(19) United States
(12) Patent Application Publication
(10) Pub. No.: US 2016/0180482 A1
(43) Pub. Date: Jun. 23, 2016

(54) PROFESSIONAL DEVELOPMENT SOLUTIONS

(71) Applicant: University of Alaska Anchorage, Anchorage, AK (US)

(72) Inventors: Lisa Cauble, Anchorage, AK (US); Katherine Branch, Anchorage, AK (US); Theresa Hofstetter, Glennallen, AK (US); Calvin Hansen, Anchorage, AK (US)

(21) Appl. No.: 14/976,176

(22) Filed: Dec. 21, 2015

Related U.S. Application Data
(60) Provisional application No. 62/094,430, filed on Dec. 19, 2014.

(51) Int. Cl. G06Q 50/20; G06Q 30/02; G06Q 10/10

(52) U.S. Cl. CPC G06Q 50/2057; G06Q 10/10; G06Q 30/0241

(57) ABSTRACT

An education management system can receive an organization profile of an organization. The organization can be associated with one or more professionals which can be employed, managed, governed, and the like by the organization. The education management can also receive a professional profile of a professional. The professional profile permits the professional to access one or more professional features of the education management system for managing a professional education goal (e.g., continuing education requirement). Based on the professional profile and the organization profile the education management system can determine that the professional is associated with the organization. Once the professional is associated with the organization, the education management system can provide one or more organization features to the organization profile. At least a portion of the organization features manages the professional education goal of the professional associated with the organization.

### CROSS REFERENCE TO RELATED APPLICATION

This application claims priority to U.S. Provisional Application No. 62/094,430 filed Dec. 19, 2014, herein incorporated by reference in its entirety.

### BACKGROUND

Many professionals are expected to participate in continuing education to maintain a license to practice in a professional field. Examples of professional fields where professionals participate in continuing education are healthcare, law, accounting, financing, engineering, and the like. Accessing, tracking, and providing continuing education is difficult for education providers, professionals, and employers of the professionals, especially for those that practice remotely. These and other shortcomings are addressed by the present disclosure.

### SUMMARY

It is to be understood that both the following general description and the following detailed description are exemplary and explanatory only and are not restrictive. Provided are methods and systems for professional development and education management of professionals, organizations of the professionals, and education providers.

In an aspect, an education management system can receive an organization profile of an organization. The organization can be associated with one or more professionals who can be employed, managed, licensed, and the like by the organization. The education management system can also receive a professional profile of a professional. The professional profile permits the professional to access one or more professional features of the education management system for managing a professional education goal (e.g., continuing education requirement). Based on the professional profile and the organization profile, the education management system can determine that the professional is associated with the organization. Once the professional is associated with the organization, the education management system can provide one or more organization features to the organization profile. At least a portion of the organization features manages the professional education goal of the professional associated with the organization.

In an aspect, provided are methods and systems for professional development. An education management system can receive a plurality of educational offerings from one or more education providers. The plurality of educational offerings can have one or more offering data entries entered into an educational offering form. The education management system can also receive one or more professional profiles from one or more professionals. The one or more professional profiles have one or more professional data entries entered into a professional form. The education management system can also receive one or more organization profiles from one or more organizations. The one or more organization profiles have one or more organization data entries entered into an organization form. Based on the one or more organization data entries and the one or more professional data entries, the education management system can associate the one or more professional profiles with the one or more organization profiles by comparing professional and organization data entries and determining a likelihood that a professional belongs to an organization. The education management system can then provide organization features to any of the one or more organization profiles that are associated with at least one of the one or more professional profiles. The organization features can manage professional features provided to the one or more professional profiles. Furthermore, the education management system can advertise at least a portion of the plurality of educational offerings to the one or more professionals based on the one or more organization data entries and the one or more offering date entries.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an example network:

FIG. 2 is a flow chart of an example method;

FIG. 3 is a flow chart of an example method; and

FIG. 4 is a block diagram of an example computer system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks. CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to managing professional development over a network. In an aspect, various professions require professional development throughout a professional's career. Professional development can include education requirements for the professional to receive licenses, maintain licenses, other mandated or self-mandated education goals, combinations thereof and the like. In order to develop professionally, the professional can take or attend educational offerings such as courses, webinars, seminars, conferences, and the like. Examples of the professions that require ongoing professional development can be lawyers, a variety of healthcare professions, engineers, and the like. Tracking, advertising, and accessing educational offerings and/or completed educational offerings can be difficult for employers, professionals, and education providers, especially for those located in remote locations.

In an aspect, an education management system can be used to address the shortcomings of professional development described herein. The education management system can facilitate professional development solutions between professionals, one or more organizations having authority over the professionals, and one or more education providers. The education management system can maintain a professional profile for each of a plurality of professionals. A professional can access the education management system through a professional portal (e.g., through a website or other interface to the education management system). Through the professional portal, the professional can create and access the professional's professional profile. Furthermore, the education management system can provide a variety of professional features on the education management system to the professional through the professional portal. The professional can update and maintain the professional profile by editing professional data entries in fields relating to the professional such as contact information, an employer, an organization associated with the professional, a professional license, expertise, interests, a username, a password, and the like. The education management system can present (e.g., advertise) to the professional one or more educational offerings from one or more education providers. Examples of educational offerings can be education courses, seminars, conferences, lectures, a series of courses, demonstrations, and the like. The educational offerings can be in-person, remote viewing offerings or both. In an aspect, all educational offerings being offered by all of the education providers of the education management system can be presented to the professional. In an aspect, the education management system can determine educational offerings to be presented to the professional based on various professional data entries in the various fields of the professional profile.

In an aspect, the education management system can provide a registration feature to the professional to register for one or more educational offerings. In an aspect, the education management system can request and accept payments from the professional registering for an educational offering. In an aspect, the education management system can track educational offerings the professional has completed by providing a portfolio of completed educational offerings. As an example, the education management system can determine that the educational offering has been completed. As another example, the education provider can send a notification of completion of an educational offering to the education management system. In yet another example, the professional can enter educational offerings that the professional completed outside of the education management system. The education management system can also track educational offerings for which the professional has registered. In an aspect, the education management system can generate reports of completed educational offerings for the professional. The education management system can share the portfolio of educational offerings with an organization. The organization can be associated with the professional. For instance, the organization can be an employer, a licensing agency, an auditing service, and the like that has some control over, authority, or relationship with the professional.

In an aspect, the education management system can identify gaps (or trends in the professional's industry) in the professional's development by comparing the professional to other similarly situated professionals and make recommendations based on the identified gaps or trends. The education management system can identify groups of similarly situated professionals by comparing professional data entries in fields of the professional profiles. For example, the education management system can group the professionals based on one or more of a profession, an organization, and the like based on the professional data entries of the professional profiles. Once the education management system has grouped the similarly situated professionals, then the education management system can identify the educational offerings that each professional in the group has taken from their respective portfolios of completed educational offerings.

In an aspect, the education management system can group similarly situated educational offerings that are identified from the portfolios of the professionals. In an aspect, the education management system can group educational offerings based on offering data entries from fields of offering forms, which describe the educational offering (discussed further below). For example, the education management system can group the educational offerings by one or more data entries such as title (e.g., same educational offerings), keywords, education provider, and the like. The education management system can count the number of educational offerings in each group. The education management system can determine which groups of similarly situated educational offerings are most attended, percentage of professionals in each group of educational offerings, and the like.

In an aspect, the education management system can compare the groups of similarly situated educational offerings to educational offerings of a professional's portfolio of completed educational offerings. In an aspect, the education management system can suggest, to the professional, educational offerings that are most attended by or trending with the group of professionals the education management system has identified the professional belongs. In an aspect, the education management system can also determine which groups of educational offerings the professional may want to complete based on the group of professionals the education management system has identified the professional belongs. For example, the education management system can determine that more than 50% of the professionals in a group of similarly situated professionals have taken a specific educational offering or one or more educational offering from a group of educational offerings. The education management system can suggest to the remaining professionals the specific educational offering or an educational offering from the group of educational offerings. The education management system can notify one or more education providers and/or one or more organizations gaps (and/or trends in the professional's industry) in the professional's development.

In an aspect, the education management system can provide organization features to an organization. The organization can access the education management system through an organization portal. Through the organization portal, the organization can create or access an organization profile for the organization. Furthermore, the education management system can provide a variety of organization features available on the education management system to the organization through the organization portal. In an aspect, the organization can manage and update the organization profile by editing organization data entries in fields relating to the organization such as name, contact information, an industry, any professionals associated with the organization, professions in the organization, education requirements, combination thereof, and the like. The education management system can associate professional profiles with organization profiles where there are substantially similar organization data entries in related fields of the professional profiles and organization profiles. Another organization feature can be managing professional development of one or more professionals that are associated with the organization. For instance, the education management system can allow the organization to administer educational offerings to the professionals associated with the organization. The education management system can receive education requirements from the organization for a professional associated with the organization, groups of professionals, and/or all of the professionals of the organization. An example organization feature can allow the organization to view and monitor professional development and education requirements of the professionals. The education management system can generate reports of the completion of educational offerings by professionals, groups of professionals, or all professionals for the organization. In an aspect, the education management system can send notifications to the organization regarding status updates of the professional development of a professional associated with the organization.

In an aspect, the education management system can provide, to one or more education providers, provider features. In an aspect, the education management system can promote or advertise one or more educational offerings that the education providers are offering. The education providers can access a provider portal of the education management system. As an example of a provider feature, the education providers can post current and upcoming educational offerings through the portal to be advertised (e.g., displayed, promoted, presented) to one or more of the professionals and one or more of the organizations. In another example, the education providers can remove and edit posted educational offerings in the portal. The education providers can enter one or more offering data entries in offering fields of a provider form for an educational offering to identify and promote the educational offering to particular professionals. The education management system can compare the offering data entries to various professional data entries in fields of the professional profile and the organization data entries of the organization profile. The education management system can determine which educational offerings would be appropriate for a particular professional or organization based on the comparison. The education management system can advertise the educational offerings or the education provider to the particular professionals and the organizations based on the determination. The education management system can offer a registration feature for the professionals to register for an educational offering. The education management system can accept a payment from the professional registering for an educational offering and provide the payment to the education provider. The education providers can receive feedback from the professional about the professional's experiences with the educational offering through the education management system.

In an aspect, an educational offering can be stored in a database by the education provider. In another aspect, the education management system can act as an intermediary between professionals and education providers where the professionals, through a computing device, can access the educational offerings through an education provider device. For example, the professional can select the educational offering in the registered educational offering view. The education management system can link the professional to a platform the education provider is using to conduct the educational offering. The platform can be on the education provider device or another server.

In an aspect, the education management system can provide a platform for the education providers to conduct an educational offering. The platform can provide for receiving content such as video of an instructor, course materials, presentations, and the like from the education provider. The education management system can provide the content to the professionals that are registered for the educational offering. In an aspect, the education management system can receive inputs such as video, text, audio data from the professional attending the educational offering. The inputs can provide comments and questions for the education provider or instructor of the educational offering. The educational offering can be provided in real-time. In an aspect, the educational offering can be recorded and provided to the professional at the request of the professional.

In an aspect, the education management system can request and obtain feedback from the professional. The education management system can provide the feedback to the education provider so the education provider can adjust the educational offering and receive information from the feedback to determine value of the educational offering and demand for particular education subjects. The education management system can monitor the activity of the professional during the educational offering to determine whether the professional is participating in the educational offering. The education management system can determine whether the professional has successfully completed the educational offering. The education management system can update the professional profile, notify the organization the professional is associated with, and/or notify the education provider whether the professional has successfully completed the educational offering or not.

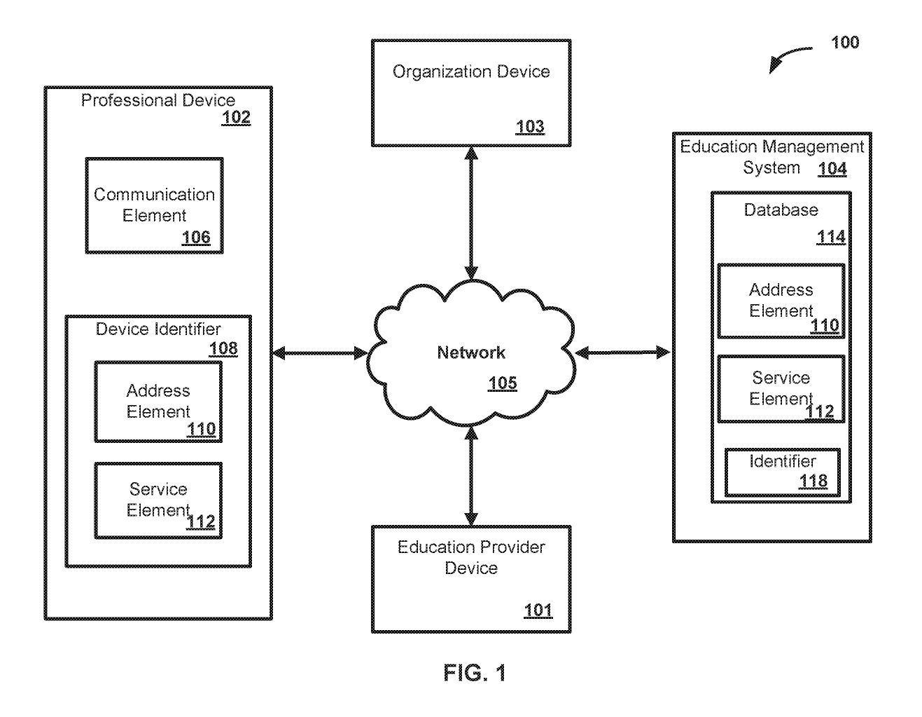

In an aspect, a system 100 can be configured to provide services such as network-related services to a device. FIG. 1 illustrates various aspects of an exemplary environment in which the present methods and systems can operate. The present disclosure is relevant to systems and methods for providing services to a device, for example, a user device such as a computer, a tablet, a mobile device, a communications terminal, or the like. The system 100 can comprise a professional device 102, an organization device 103, and an education provider device 101 in communication with an education management system 104, which can be a computing device such as a server, for example. The organization device 103 and the education provider device 101 can be a user device such as the professional device 102. The education management system 104 can be disposed locally or remotely relative to the professional device 102. As an example, the professional device 102, the organization device 103, the education provider device 101, and the education management system 104 can be in communication via a private and/or public network 105 such as the Internet or a local area network. Other forms of communications can be used such as wired and wireless telecommunication channels, for example.

In an aspect, the professional device 102, the organization device 103, and the education provider device 101 can be an electronic device such as a computer, a smartphone, a laptop, a tablet, a set top box, a display device, or other device capable of communicating with the education management system 104. As an example, the professional device 102, which can be a similar device comprising similar components as the organization device 103 and the education provider device 101, can comprise a communication element 106 for providing an interface to a user, such as a professional, an organization, or an education provider, to interact with the professional device 102 and/or the education management system 104. The communication element 106 can be any interface for presenting and/or receiving information to/from the user, such as user feedback. An example interface may be communication interface such as a web browser (e.g., Internet Explorer®, Mozilla Firefox®, Google Chrome®, Safari®, or the like). Other software, hardware, and/or interfaces can be used to provide communication between the user and one or more of the professional device 102 and the education management system 104. As an example, the communication element 106 can request or query various files from a local source and/or a remote source. As a further example, the communication element 106 can transmit data to a local or remote device such as the education management system 104.

In an aspect, the professional device 102 can be associated with a user identifier or device identifier 108. As an example, the device identifier 108 can be any identifier, token, character, string, or the like, for differentiating one user or user device (e.g., the professional device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the professional device 102, a state of the professional device 102, a locator, and/or a label or classifier. Other information can be represented by the device identifier 108.

In an aspect, the device identifier 108 can comprise an address element 110 and a service element 112. The address element 110 can comprise or provide an internet protocol address, a network address, a media access control (MAC) address, an Internet address, or the like. As an example, the address element 110 can be relied upon to establish a communication session between the professional device 102 and the education management system 104 or other devices such as organization device 103, and education provider device 101 and/or networks. As a further example, the address element 110 can be used as an identifier or locator of the professional device 102. The address element 110 can be persistent for a particular network.

In an aspect, the service element 112 can comprise an identification of a service provider associated with the professional device 102 and/or with the class of professional device 102. The class of the professional device 102 can be related to a type of device, capability of device, type of service being provided, and/or a level of service (e.g., business class, service tier, service package, etc.). As an example, the service element 112 can comprise information relating to or provided by a communication service provider (e.g., Internet service provider) that is providing or enabling data flow such as communication services to the professional device 102. As a further example, the service element 112 can comprise information relating to a preferred service provider for one or more particular services relating to the professional device 102. In an aspect, the address element 110 can be used to identify or retrieve data from the service element 112, or vise versa. As a further example, one or more of the address element 110 and the service element 112 can be stored remotely from the professional device 102 and retrieved by one or more devices such as the professional device 102 and the education management system 104. Other information can be represented by the service element 112.

In an aspect, the education management system 104 can be a server for communicating with the professional device 102, the organization device 103, and the education provider device 101. As an example, the education management system 104 can communicate with the professional device 102, the organization device 103, and the education provider device 101 for providing data and/or services. As an example, the education management system 104 can provide services such as network (e.g., Internet) connectivity, network printing, media management (e.g., media server), content services, streaming services, broadband services, education management, professional development services, or other network-related services. In an aspect, the education management system 104 can allow the professional device 102, the organization device 103, and the education provider device 101 to interact with remote resources such as data, devices, and files. As an example, the computing device can be configured as (or disposed at) a central location (e.g., a headend, or processing facility), which can receive content (e.g., data, input programming) from multiple sources. The education management system 104 can combine the content from the multiple sources and can distribute the content to user (e.g., subscriber) locations via a distribution system.

In an aspect, the education management system 104 can manage the communication between the professional device 102, the organization device 103, the education provider device 101 and a database 114 for sending and receiving data therebetween. As an example, the database 114 can store a plurality of files (e.g., web page templates, and/or web pages), user identifiers or records, or other information. In an aspect, the web page and/or web template can be stored on a web server and the web page can be created dynamically using the templates and the data stored in the database 114. As a further example, the professional device 102, the organization device 103, and the education provider device 101 can request and/or retrieve a file from the database 114. In an aspect, the database 114 can store information relating to the professional device 102, the organization device 103, and the education provider device 101 such as the address element 110 and/or the service element 112. As an example, the education management system 104 can obtain the device identifier 108 from the professional device 102, the organization device 103, or the education provider device 101 and retrieve information from the database 114 such as the address element 110 and/or the service elements 112. As a further example, the education management system 104 can obtain the address element 110 from the professional device 102, the organization device 103, and the education provider device 101 and can retrieve the service element 112 from the database 114, or vice versa. Any information can be stored in and retrieved from the database 114. The database 114 can be disposed remotely from the education management system 104 and accessed via direct or indirect connection. The database 114 can be integrated with the education management system 104 or some other device or system.

In an aspect, the education management system 104 can provide professional development services to: education providers that provide one or more educational offerings, professionals seeking to the take an educational offering, and organizations that are associated with the professionals. The professional development services (e.g., provider features) provided to the education providers by the education management system 104 will be described with respect to the education provider device 101. The professional development services (e.g., professional features) provided to the professionals by the education management system 104 will be described with respect to the professional device 102. The professional development services (e.g., organization features) provided to the organizations by the education management system 104 will be described with respect to the organization device 103.

In an aspect, the education management system 104 can comprise a web-based service for professional development of professionals, organizations, and education providers. The education management system 104 can include a website having a plurality of linked web pages through which a visitor can navigate. In an aspect, the web pages and/or web page templates can be stored in the database 114. In an aspect, web page templates can be stored on a web server and the web pages can be created dynamically using the web page templates and data that are stored in the database 114. An education provider can access the education management system 104 by using the education provider device 101. The education management system 104 can have an education provider portal from which the education provider can enter the education management system 104 using the education provider device 101. The education management system 104 at the education provider portal can have an access control such as a user login through which the education provider can login with user credentials to an education provider portal. The education provider portal can also allow the creation of a provider profile for the education provider. When the provider profile is being created, the education management system 104 can prompt the education provider to fill in a plurality of fields of a provider form. The plurality of fields can be filled in with one or more provider data entries. The plurality of fields and provider data entries can comprise one or more of a name of the education provider, a profession or professions the education provider offers educational offerings (e.g., healthcare, law, engineering, accounting), contact information, address information, payment information, descriptions of the education provider, login user credentials, combinations thereof, and the like. The education management system 104 can store the provider profile in the database 114 so that the education provider can access the education provider portal the next time the education provider accesses the education management system 104.

In an aspect, when the education provider accesses the education management system 104 through the education provider portal, the education management system 104 can present the education provider with provider features. The education management system 104 can allow provider features such as allowing the education provider to advertise an educational offering, edit existing educational offerings, analyze past educational offerings, and the like. When advertising an educational offering, the education management system 104 can have the education provider fill a plurality of fields of an offering form. Each of the plurality of fields can be filled in with one or more offering data entries The plurality of fields and offering data entries can include, a name of the educational offering, a profession associated with the educational offering, a type of educational offering (e.g., a web course, a training, an academic program, an academic course, a seminar, a conference, combinations thereof, and the like), description of the educational offering, keywords identifying the educational offering, an instructor, a date, a time, a location, contact information, cost, combinations thereof, and the like. In an aspect, the education management system 104 can store the educational offering form in the database 114. The offering data entries provided in the fields can be used by the education management system 104 to produce a catalog of educational offerings, which can be viewed by professionals, organizations, and education providers. In an aspect, the educational offering can also be stored to the database 114, which can be accessed through the education management system 104. In another aspect, the education management system 104 can act as an intermediary between professionals and education providers where the professionals, through the professional device 102, can access the educational offerings through the education provider device 101.

In an aspect, the education management system 104 can allow the education provider to edit existing educational offerings. For example, the education provider can edit any of the fields of the offering form as described above. The education provider can cancel the educational offering altogether, issue refunds, combinations thereof, and the like.

In an aspect, the education management system 104 can also allow the education provider to evaluate the educational offering once the educational offering is over. The education management system 104 can produce, distribute, and receive evaluations of the educational offering from professionals attending the educational offering. In an aspect, the education provider can run reports through the education management system 104 based on different fields of registration forms discussed further below such as cost, attendance, successful completions of the educational offering, professionals attending, organizations of the professionals attending, contact lists of professionals attending, combinations thereof, and the like. The reports can be generated using information provided in forms of one or more of an organization form, a professional form, an offering form, a registration form, combinations thereof, and the like.

In an aspect, the education management system 104 can provide a number of other services for the education provider such as, but not limited to, online registration for the educational offering; accepting payments for the educational offering from professionals and organizations; depositing the payments into an account of the education provider; generating and providing a roster of professionals enrolled in the educational offering; facilitating communication between professionals and education providers, and advertising the education provider's services, courses, brand, combinations thereof, and the like.

In an aspect, a professional can access the education management system 104 through the professional device 102. The education management system 104 can have a professional portal from which the professional can enter the education management system 104. The education management system 104 at the professional portal can have an access control such as a login credential through which the professional can login with user credentials to the professional portal. The professional portal can also facilitate creation of a professional profile for the professional. When a professional profile is created, the education management system 104 can prompt the professional to fill in a plurality of fields of a professional form. The plurality of fields can be filled in with one or more professional data entries. The plurality of fields and professional data entries can comprise a name of the professional, a profession or professions the professional is a part of (e.g., healthcare, law, engineering, accounting), contact information, professional licenses, address information, payment information, interests, organizations that the professional is a member, login credentials, combinations thereof, and the like. In an aspect, some or all of the data entries can be stored separately from the professional profile (e.g., payment information can be stored elsewhere). In an aspect, the professional can manually fill in the fields of the professional form. In an aspect, the education management system 104 can provide choices for the fields such as a list of organizations that are registered with the education management system 104, interests, professions, combinations thereof, and the like. The education management system 104 can store the professional profile in the database 114 so that the professional can access the professional portal and the professional profile the next time the professional accesses the education management system 104.

In an aspect, when the professional accesses the education management system 104 through the professional portal, the education management system 104 can present the professional with several professional features. The education management system 104 can allow the professional to search for an educational offering, register for educational offerings, view and edit educational offerings for which the professional is currently registered, view a portfolio of completed educational offerings, add completed offerings to the portfolio, edit the professional profile including areas of interest, combinations thereof, and the like.

In an aspect, the professional can search for educational offerings in the catalog of educational offerings maintained by the education management system 104. The catalog can contain educational offerings advertised by the education providers. In an aspect, the professional can search the catalog in the catalog's entirety, which is stored in the database 114. In another example, the professional can search the catalog by any of the offering fields that the education provider completed. For example, the professional can search the catalog by one or more of a profession associated with the educational offering, a type of offering (e.g., a web course, trainings, academic programs, academic courses, seminars, conferences, combinations thereof, and the like), keywords identifying the educational offering, an instructor, a date, a time, a location, cost, an area of interest, a number of continuing education credits, whether continuing education credits are offered by the educational offering, combinations thereof, and the like. In an aspect, popular fields can be presented to the professional automatically. In another aspect, the professional can type one or more keywords into a search engine, which can search the education management system 104 or search the descriptions of the educational offerings and other fields.

In an aspect, after the professional searches the catalog, the professional can be provided with one or more educational offerings from which to select. The educational offerings can be presented with a short description using one or more of the offering data entries in the fields of the educational offering. For example, the educational offerings can be presented by a list of titles of the educational offerings. The professional can select by inputting a command via a touchscreen, a voice activation module, a mouse, a stylus, a text command, combinations thereof, and the like of the professional device 102. In general, the professional can navigate the education management system 104 through one or more of the commands. When an educational offering is selected from the catalog, a more detailed description of the educational offering can be presented to the professional.

In an aspect, the professional can contact the education provider advertising the educational offering to register for the educational offering. In an aspect, the education management system 104 can provide a registration feature. The education management system 104 can provide to the professional a link to register for the educational offering. Once the link is selected by the professional, a registration form can be presented to the professional. The registration form can comprise a plurality of registration fields for one or more registration data entries to be inputted. In an aspect, the professional can manually fill in the fields. In another aspect, the education management system 104 can automatically fill in at least a portion of the registration fields by taking professional data entries from corresponding professional fields of the professional's professional profile. The education management system 104 can accept payments for the educational offering from the professional or an organization identified with the professional during the registration process. The payments can be withdrawn from a professional's account or an account of an organization. The payment withdrawn can be deposited into an account of the education provider that is providing the educational offering.

In an aspect, once the professional is registered for the educational offering, the education management system 104 can send notifications to the education provider, and any organizations associated with the professional. The education management system 104 can also store the professional's registration form and add the professional to a list of professionals taking the educational offering. The education provider can access the list to gather information of the professionals attending and determine the attendance for the educational offering. The education management system 104 can add the educational offering that is registered to a registered educational offering view that is accessible to the professional. In the registered educational offering view the professional can view the educational offerings for which the professional has registered. The professional can also manage registered educational offerings in the registered educational offering view. For example, the professional can unregister for an educational offering. In another example, the professional can edit information provided during the registration process.

In an aspect, the professional can access, through the registered educational offering view, the educational offering. In an aspect, the educational offering can be accessed from the database 114 which is where the education provider stored the educational offering. In another aspect, the education management system 104 can act as an intermediary between professionals and education providers where the professionals, through the professional device 102, can access the educational offerings through the education provider device 101. For example, the professional can select the educational offering in the registered educational offering view. The education management system 104 can link the professional to a platform the education provider is using to conduct the educational offering. The platform can be on the education provider device 101 or another server.

In an aspect, the professional can access a portfolio of educational offerings completed by the professional through the professional portal. The education management system 104 can receive a notification from an education provider that the professional has completed a particular educational offering. In another aspect, the education management system 104 can automatically determine whether or not the professional has completed the educational offering. For example, the education management system 104 can monitor activity of the professional while the professional is completing the offering. For example, the education management system can require the user to periodically acknowledge that the professional is still viewing the educational offering. Once determined that the professional has completed the educational offering, the education management system 104 can update the portfolio of the professional by adding the educational offering with a completion notification to the portfolio. In an aspect, the professional can have one or more professional education goals such as an education requirement to complete a specified number of offerings and/or credit hours. The education management system 104 can update and track the completion of the professional education goals in the portfolio of the professional.

In an aspect, the professional can add self-reported educational offerings that the professional has completed outside of the education management system 104 to the portfolio. The education management system 104 can provide a self-reporting form with a plurality of fields to the professional. The fields can require information about a self-reported educational offering such as a title, a description, dates, a credit type, a number of credits, a number of credit hours, combinations thereof, and the like. In an aspect, the professional can upload any supporting documentation or certification received with the self-reported educational offering. The self-reported educational offering can be added to the portfolio of the professional. The education management system 104 can apply the self-reported educational offering to any professional education goals.

In an aspect, the professional can use the portfolio to run reports, print reports, submit the reports to any associated organization, combinations thereof, and the like. For example, the professional can use the portfolio in the education management system 104 to generate reports as to how many credits or credit hours were completed.

In an aspect, the education management system 104 through the professional portal can allow the professional to update professional data entries in the fields of the professional profile. For example, if the professional changes organizations, then the professional can update the field relating to organizations. In an aspect, after an event such as a period of inactivity of the professional by not logging into the education management system 104, the education management system 104 can notify the professional to update the professional profile. When the professional accesses the education management system 104 after the event, then the education management system 104 can prompt the professional to update the professional profile.

In an aspect, an organization can access the education management system 104 through the organization device 103. The education management system 104 can comprise an organization portal from which the organization can enter the education management system 104. The education management system 104 at the organization portal can have an access control such as a user login through which the organization can login with login credentials to the organization portal. To login to the organization portal, a creation of an organization profile may need to be completed. The organization portal can allow the creation of an organization profile for the organization. When an organization profile is created, the education management system 104 can prompt the organization to fill in a plurality of fields of an organization form with one or more organization data entries. The plurality of fields can include a name of the organization, a profession or professions the organization comprises of (e.g., healthcare, legal, engineering, accounting, and subsets thereof such as physicians, nurses, mental health providers, and the like within healthcare), contact information, payment information, one or more professionals associated with the organization, login credentials, combinations thereof, and the like. In an aspect, the organization can manually fill in the fields of the organization form. In an aspect, the education management system 104 can provide choices for the fields such as a list of professionals that are associated with the education management system 104, professions and the like. The education management system 104 can store the organization profile in the database 114 so that the organization can access the organization profile and the organization portal the next time the organization accesses the education management system 104.

In an aspect, when the organization establishes the organization profile, the education management system 104 can add the organization to a list of organizations that can be presented to the professionals. The list of organizations can be presented to the professional when the professional is asked which organizations the professional belongs to when the professional creates the professional profile. In an aspect, the education management system 104 can provide the list of organizations to education providers so that the education providers can produce targeted educational offerings to specific organizations. The list of organizations can be helpful for the education providers to determine which educational offerings to advertise based on the available audience of registered organizations.

In an aspect, once the organization establishes the organization profile, the education management system 104 can associate the organization with professionals that are a part of the organization. The education management system 104 can associate the organization with professionals that are a part of the organization by matching names of professionals provided by the organization to names within a name field of the professional profiles. As an example, professional profile fields having professional data entries that list the organizations the professional is a part of can be matched to the organization names within a name field of the organization profile. Other fields can be used to associate professionals with an organization such as addresses or other common fields. The education management system 104 can prompt the organization, the professional, or both to associate the organization with the professional.

In an aspect, privacy options can be incorporated into the various provider profiles, professional profiles, and organization profiles so selected information between the education provider, professional, and the organization can or cannot be shared between the separate groups (e.g., education provider, professional, and organization) or other users within the groups.

In an aspect, the education management system 104 can provide several organization features to the organizations to manage goals such as manage education requirements of associated professionals, monitor educational offering activity and accomplishments of the professionals associated with the organization, receive notifications of incomplete education requirements and due dates, run reports for accreditation requirements, administer educational offerings to professionals associated with the organization, and advertise and manage educational offerings internally or publicly, combinations thereof, and the like.

In an aspect, the education management system 104 can allow the organization to manage professional education goals such as education requirements of one or more professionals associated with the organization. For example, the organization can select how many educational offerings the organization wants the professional to complete. As another example, the organization can set a due date when the educational offering needs to be completed. As another example, the organization can select specific educational offerings that the organization wants one or more of the professionals associated with the organization to participate. As another example, the organization can require different groups of professionals within the organization to participate in certain educational offerings. For example, a hospital can have various professionals in different professions employed. In the example, the hospital can want all physicians to participate in a physician educational offering, and nurses participate in a nursing educational offering. Within the physicians, the hospital can require cardiologists to take a cardiology educational offering. In another example, the hospital can require all professional within the cardiology department to take the cardiology course. In another example, the hospital can require all professionals employed at the hospital to take an educational offering. In an aspect, the education management system 104 can provide organization features to sort professionals associated with the organization so that the organization can assign education requirements to those professionals. The education management system 104 can use fields associated with the professionals to put them in groups, provide lists of professionals to the organization, and allow the organization to assign educational offerings and requirements to those groups.

In an aspect, the organization can manage professional education goals by monitoring educational offering registration activity and accomplishments. For example, the organization can monitor completion of an educational offering by the professionals associated with the organization through the organization portal of the education management system 104. The education management system 104 can allow the organization to view which educational offerings have been completed by a professional or by a group of professionals. The education management system 104 can provide the organization with an organization feature to view the educational offerings for which a professional or group of professionals is registered. In another example, the organization can select a professional within the organization to view the professional's portfolio, upcoming registered educational offerings, combinations thereof, and the like. The organization can select a group of professionals to view the group of professionals' portfolios, upcoming registered educational offerings, combinations thereof, and the like. In an aspect, the education management system 104 can allow the organization to select professional data entries in one or more fields by which to sort/filter the different professionals of the organization into groups. The education management system 104 can use the professional data entries and fields to search the database 114 of the professional profiles and professional forms. The education management system 104 can select/filter the particular professionals by matching the fields and the professional data entries within the professional profiles with the fields and professional data entries selected by the organization for searching. The education management system 104 can create a report or print a list of accomplishments of professionals for any internal documentation or for accreditation purposes.

In an aspect, the organization can be an education provider. The education management system 104 can provide to the organization through the organization portal provider features given to an education provider as described herein. As such, the organization can publically advertise educational offerings offered by the organization. The education management system 104 can provide to the organization, organization features to provide private internal educational offerings to those professionals that are associated with the organization or to a portion/group of the professionals associated with the organization.

In an aspect, the education management system 104 can notify the organization of an event of a professional. For example, the education management system 104 can notify the organization by email, a text message, mail, combinations thereof, and the like when an event occurs. The organization can provide to the education management system 104 different events for which the organization wants the education management system 104 to monitor. For example, the education management system 104 can monitor for an event such as overdue educational offerings, missed educational offerings, incompletion of education goals and requirements, status of education goals of a professional after a specified time, combinations thereof, and the like.

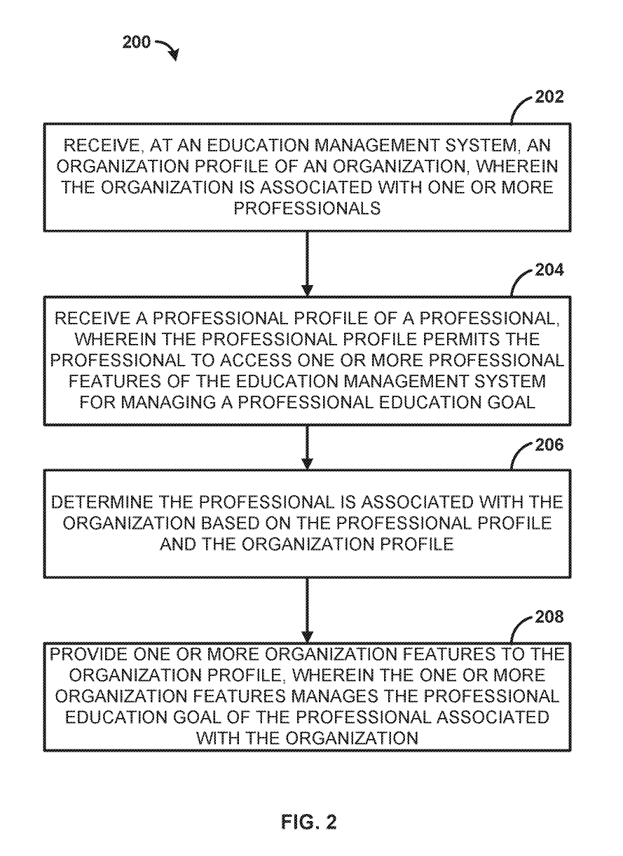

FIG. 2 illustrates a method 200 of education management. In step 202, an education management system (e.g., education management system 104 of FIG. 1) can receive an organization profile of an organization. The organization can manage or be associated with one or more professionals. An organization portal of the education management system can allow creation of an organization profile for the organization. When an organization profile is created, the education management system can prompt the organization to fill in a plurality of fields of an organization form with one or more organization data entries. The plurality of fields and organization data entries can include a name of the organization, a profession or professions of which the organization comprises (e.g., healthcare, legal, engineering, accounting, and subsets thereof such as physicians, nurses, mental health providers, and the like within healthcare), contact information, payment information, one or more professionals associated with the organization, login credentials, combinations thereof, and the like. The organization can manually fill in the fields of the organization form, and/or the education management system can provide choices for the fields such as a list of professionals that are associated with the education management system, a list of professions, and the like. The education management system can store the organization profile in a database (e.g., the database 114 of FIG. 1) so that the organization can access the organization profile and the organization portal the next time the organization accesses the education management system. The education management system can use the organization profile to perform organization features, professional features, education provider features, combinations thereof, and other methods of the education management system.

In step 204, the education management system can receive a professional profile of a professional. The professional profile can permit the professional to access one or more professional features of the education management system for managing an education goal of the professional. A professional portal of the education management system can allow the creation of a professional profile for the professional. When a professional profile is created, the education management system can prompt the professional to fill in a plurality of fields of a professional form. The plurality of fields can include a name of the professional, profession or professions the professional is a part of (e.g., healthcare, law, engineering, accounting), contact information, professional licenses, address information, payment information, interests, organizations that the professional is a member, login credentials, combinations thereof, and the like. As an example, the professional can manually fill in the fields of the professional form. As another example, the education management system can provide choices for the fields such as a list of organizations that are registered with the education management system, interests, professions combinations thereof, and the like. The education management system can store the professional profile in the database so that the professional can access the professional portal and the professional profile the next time the professional accesses the education management system. In an aspect, the education management system can use the professional profile to perform organization features, professional features, education provider features, combinations thereof, and other methods of the education management system.

In an aspect, the professional features provided by the education management system to the professional can allow the professional to search for an educational offering, register for educational offerings, pay for educational offerings, view and edit educational offerings for which the professional is currently registered, view a portfolio of completed educational offerings, add completed educational offerings to the portfolio, track professional education goals in the portfolio, edit the professional profile including areas of interest, combinations thereof, and the like. The professional education goals that can be managed by the professional features can include education requirements assigned by an organization associated with the professional, personal goals of the professional, and the like.

In step 206, the education management system can determine the professional is associated with the organization. The education management system can determine an association based on the organization profile and the professional profile. Once the organization establishes the organization profile, the education management system can associate the organization with one or more professionals that are a part of the organization. The education management system can associate the organization with professionals by comparing data entries of one or more fields of the organization profile with data entries of one or more fields of the professional profile. The professional profile can be associated with the organization profile when at least one of the data entries of the one or more fields of the professional profile is substantially similar to at least one of the data entries of the one or more fields of the organization profile.

For example, the education management system can match names of professionals provided by the organization to names of the professional data entries in a name field of the professional profiles. In another example, professional profile fields having professional data entries that list the organizations the professional is a part of can be matched to the organization name in the organization profile. In other examples, other fields can be used to associate professionals with an organization such as addresses or other common fields. The education management system can prompt the organization, the professional, or both whether to associate the organization with the professional. When a new professional profile is created, the education management system can list the organization as a selection choice when the professional is creating the professional profile. If selected by the professional, the education management system can associate the professional to the organization.

In step 208, the education management system can provide one or more organization features of the education management system to the organization profile. Of the organization features provided to the organization, at least a portion of the organization features allow the organization to manage the education goals of the professional associated with the organization. The education management system can provide several organization features to the organization to manage goals. Examples of the organization features can comprise manage education requirements of associated professionals, monitor educational offering activity and accomplishments of the professionals associated with the organization, provide access to the educational offering associated with the professional profile, and provide access to the portfolio of completed educational offerings of the professional. In an aspect, the organization can receive notifications of incomplete and complete education requirements, due dates, run reports for accreditation requirements, administer educational offerings to professionals associated with the organization, and advertise and manage educational offerings internally or publicly, combinations thereof, and the like.

In an aspect of method 200, the education management system can provide provider features to education providers. Provider features can comprise allowing the education provider to advertise an educational offering on the education management system, edit existing educational offerings, analyze past educational offerings, and the like. In an aspect, the education provider can send a request to the education management system to advertise an educational offering. The education management system can receive the request. The education management system can then advertise the educational offering to organizations and professional by posting the educational offering in a catalog on the education management system. In an aspect, the education management system can use offering data entries of an offering form comprising a plurality of fields which provide information about the educational offering to perform targeted advertisements. In an aspect, the education management system can compare offering data entries of the educational offering to professional data entries of the professional profile to determine whether the professional may be interested in the educational offering or whether the educational offering is an educational offering that can fulfill an educational goal of the professional. The education management system can determine whether one or more data entries of one or more fields of the educational offering are substantially similar to one or more data entries of one or more fields of the professional profile. The education management system can advertise the educational offering to the professional when the one or more data entries of the educational offering are substantially similar to the one or more data entries of the professional profile.

In an aspect, the professional can send a search request for educational offerings which the education management system can receive. The education management system can perform a search of the catalog of educational offerings based on the search request and provide one or more educational offerings when the search matches the search request to one or more offering data entries of one or more fields of an educational offering. The education management system can receive a request from the professional to register for an educational offering. The education management system can provide a registration form for the educational offering to the professional. In an aspect, the professional can complete the registration form and send the registration form to the education management system. The education management system can receive the registration form and associate the educational offering with the professional profile.

In an aspect, the organization can be the education provider and have access to the provider features. In an aspect, the organization can conduct educational offerings. In an aspect, the organization can provide educational offerings to professionals associated with the organization.

In an aspect, the education management system can receive an education requirement from the organization for the professional associated with the organization. The education management system can assign the education requirement to the professional profile. The education requirement can be one or more educational offerings provided by an education provider, and/or the organization. In an aspect, the education requirement can be assigned to a group of professionals associated with the organization. The group of professionals can comprise professionals in a specific department, professionals of one or more professions, the entire organization, combinations thereof, and the like. In an aspect, the education management system can monitor a completion status of the education requirement and provide notifications of the completion of the education requirement by the one or more professionals.

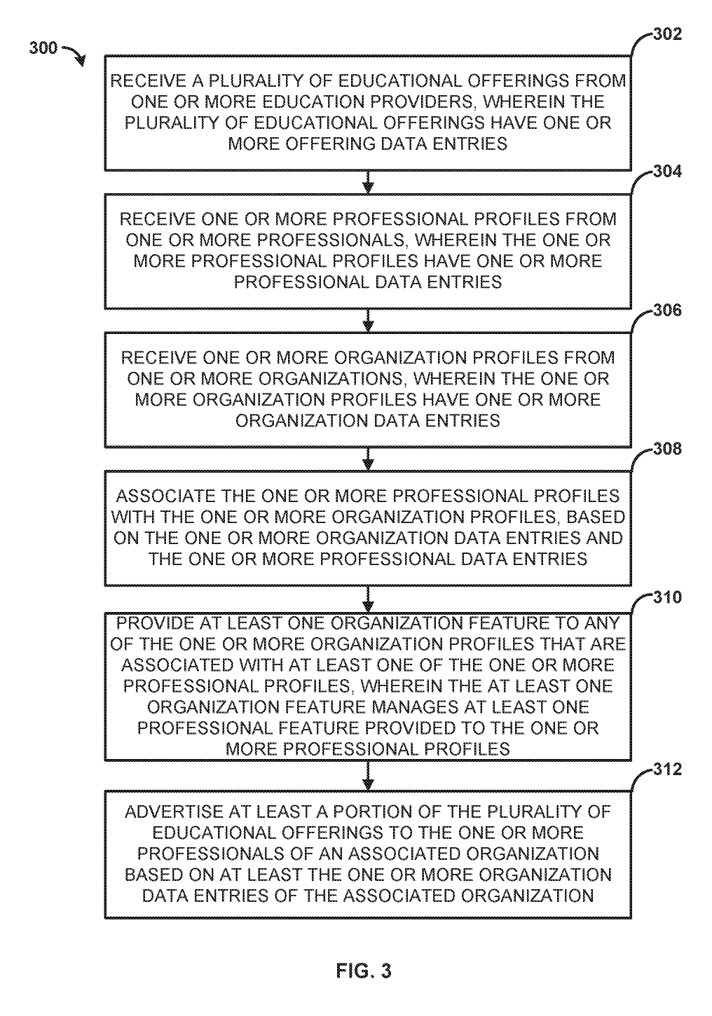

FIG. 3 illustrates a method 300 of education management. In step 302, an education management system (e.g., education management system 104 of FIG. 1) can receive a plurality of educational offerings from one or more education providers. Of the plurality of educational offerings each can have one or more offering data entries. An education provider can send a request to advertise an educational offering. The request can include an educational offering form that comprises a plurality of fields. Each field can include one or more offering data entries. The plurality of fields and the offering data entries can comprise a name of the educational offering, profession associated with the educational offering, type of educational offering (e.g., web course, trainings, academic programs, academic courses, seminars, conferences, and the like), description of the educational offering, keywords identifying the educational offering, an instructor, a date, a time, a location, contact information, a cost, a number of credit hours, combinations thereof, and the like. An educational offering along with corresponding offering data entries for each educational offering can be stored in a database (e.g., database 114 of FIG. 1) of the education management system.

In step 304, the education management system can receive one or more professional profiles from one or more professionals. Each of the professional profiles can have one or more professional data entries. The professional data entries can include a name of the professional, profession or professions the professional is a part of (e.g., healthcare, law, engineering, accounting), contact information, professional licenses, address information, payment information, interests, organizations that the professional is a member, login credentials, and the like. In an aspect, the professional can manually fill in the fields of a professional form. In an aspect, the education management system can provide choices for the fields such as a list of organizations that are registered with the education management system, interests, professions, combinations thereof, and the like. A professional profile along with corresponding professional data entries from each professional can be stored in the database of the education management system.

In step 306, the education management system can receive one or more organization profiles from one or more organizations. Each of the organization profiles can have one or more organization data entries. A plurality of fields in the organization profiles and the corresponding organization data entries can include a name of the organization, a profession or professions the organization comprises of (e.g., healthcare, legal, engineering, accounting, and subsets thereof such as physicians, nurses, mental health providers, and the like within healthcare), contact information, payment information, one or more professionals associated with the organization, login credentials, combinations thereof, and the like. In an aspect, the organization can manually fill in the fields of an organization form with the organization data entries. In an aspect, the education management system can provide choices for the fields such as a list of professionals that are associated with the education management system, a list of professions, combinations thereof, and the like. An organization profiles form along with corresponding organization data entries from each education provider can be stored in the database of the education management system.

In step 308, the education management system can associate the one or more professional profiles with one or more organization profiles. The education management system can associate the profiles based on the organization data entries and the professional data entries. The education management system can determine an association based on the organization profile and the professional profile. Once the organization establishes the organization profile, the education management system can associate the organization with professionals that are a part of the organization. The education management system can associate the organization with professionals that are a part of the organization by matching names of professionals provided by the organization as organization data entries to names of the professional data entries in the fields (e.g., name field) of the professional profiles. In another aspect, professional profile fields having professional data entries that list the organizations the professional is a part of can be matched to the organization name in the organization profile. In an aspect, other fields can be used to associate professionals with an organization such as addresses or other common fields. In an aspect, the education management system can prompt the organization, the professional, or both to associate the organization with the professional or not. In an aspect, when a professional profile is created, the education management system can list the organization as a selection choice when the professional is creating the professional profile. If selected by the professional, the education management system can associate the professional to the organization.

In step 310, the education management system can provide at least one organization feature to any of the one or more organization profiles that are associated with at least one of the one or more professional profiles. The at least one organization feature can manage at least one professional feature provided to the one or more professional profiles. The organization features can include features that manage education goals, education requirements, and the like. The education management system can provide several organization features to the organizations to manage education goals such as manage education requirements of associated professionals, monitor educational offering activity and accomplishment of the professionals associated with the organization, receive notifications of incomplete and complete education requirements and due dates, run reports for accreditation requirements, administer educational offerings to professionals associated with the organization, advertise and manage educational offerings internally or publicly, combinations thereof, and the like. As an example, the education management system can provide an associated organization, (e.g., organization associated with a professional) access to an educational offering associated with the professional profile. As another example, the education management system can provide the associated organization access to a portfolio of completed educations offerings.

In step 312, the education management system can advertise at least a portion of the plurality of educational offerings to the one or more professionals of the associated organization. The portion of the educational offerings can be determined based on organization data entries, professional data entries, offering data entries, organization features, professional features, any combination thereof, and the like. In an aspect, the organization data entries can be used to determine the educational offerings available to advertise to a professional. The education management system can determine which of the one or more professionals, one or more organizations, or both to advertise an educational offering by comparing and matching offering data entries to organization and professional data entries. When matches exist, the education management system can advertise one or more educational offerings that match to an organization and/or a professional.

In an aspect, the professional can send a search request for educational offerings which the education management system can receive. The education management system can perform a search of the catalog of educational offerings based on the search request and provide one or more educational offerings when the search matches the search request to one or more offering data entries of one or more fields of an educational offering. In an aspect, the education management system can receive a request from the professional to register for at least one educational offering of the plurality of educational offerings corresponding to the professional. The education management system can provide a registration form for the at least one educational offering to the professional. In an aspect, the professional can complete the registration form and send the registration form to the education management system. The education management system can receive the registration form and associate the at least one educational offering with a professional profile of the professional.

In an aspect, the education management system can receive a notification from the professional or an education provider that the professional has completed an educational offering (e.g., educational offering for which the professional registered, an educational offering completed outside of the education management system). The education management system can add the educational offering to a portfolio of completed educational offerings. The portfolio can be associated with the professional profile.

In an aspect, the organization can be the education provider and have access to the education provider features. In an aspect, the organization can conduct educational offerings. In an aspect, the organization can provide educational offerings to professionals associated with the organization.

In an aspect, the education management system can receive an education requirement from the associated organization for the professional associated with the organization. The education management system can assign the education requirement to the professional profile. The education requirement can be one or more educational offerings provided by an education provider, and/or the organization. In an aspect, the education requirement can be assigned to a group of professionals associated with the organization. The group of professionals can comprise professionals in a specific department, professionals of one or more professions, the entire organization, combinations thereof, and the like. In an aspect, the education management system can monitor a completion status of the education requirement and provide notifications of the completion of the education requirement by the one or more professionals.

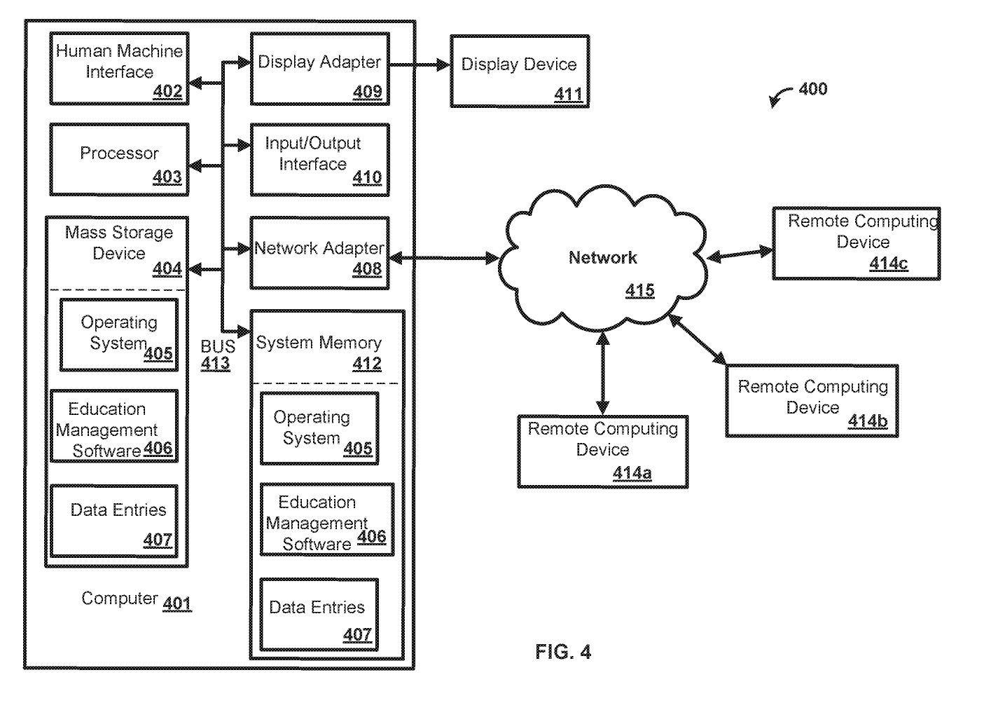

In an exemplary aspect, the methods and systems can be implemented on a computer 401 as illustrated in FIG. 4 and described below. By way of example, education management system 104 of FIG. 1 can be a computer 401 as illustrated in FIG. 4. Similarly, the methods and systems disclosed can utilize one or more computers to perform one or more functions in one or more locations. FIG. 4 is a block diagram illustrating an exemplary operating environment 400 for performing the disclosed methods. This exemplary operating environment 400 is only an example of an operating environment and is not intended to suggest any limitation as to the scope of use or functionality of operating environment architecture. Neither should the operating environment 400 be interpreted as having any dependency or requirement relating to any one or combination of components illustrated in the exemplary operating environment 400.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 401. The computer 401 can comprise one or more components, such as one or more processors 403, a system memory 412, and a bus 413 that couples various components of the computer 401 including the one or more processors 403 to the system memory 412. In the case of multiple processors 403, the computer 401 can utilize parallel computing.

The bus 413 can comprise one or more of several possible types of bus structures, such as a memory bus, memory controller, a peripheral bus, an accelerated graphics port, and a processor or local bus using any of a variety of bus architectures. The bus 413, and all buses specified in this description can also be implemented over a wired or wireless network connection and one or more of the components of the computer 401, such as the one or more processors 403, a mass storage device 404, an operating system 405, education management software 406, data entries 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system. Examples of the remote computing devices can be education provider device 101, professional device 102, and organization device 103 of FIG. 1.

The computer 401 comprises a variety of computer readable media. Exemplary readable media can be any available media that is accessible by the computer 401 and comprises, for example and not meant to be limiting, both volatile and non-volatile media, removable and non-removable media. The system memory 412 can comprise computer readable media in the form of volatile memory, such as random access memory (RAM), and/or non-volatile memory, such as read only memory (ROM). The system memory 412 can comprise data such as data entries 407 and/or program modules such as operating system 405 and education management software 406 that are accessible to and/or are operated on by the one or more processors 403.

In another aspect, the computer 401 can also comprise other removable non-removable, volatile non-volatile computer storage media. The mass storage device 404 can provide non-volatile storage of computer code, computer readable instructions, data structures, program modules, and other data for the computer 401. For example, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and education management software 406. One or more of the operating system 405 and education management software 406 (or some combination thereof) can comprise elements of program modules and the education management software 406. Data entries 407 can also be stored on the mass storage device 404. Data entries 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 415.

In another aspect, the user can enter commands and information into the computer 401 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 403 via a human machine interface 402 that is coupled to the bus 413, but can be connected by other interface and bus structures, such as a parallel port, game port, an IEEE 1394 Port (also known as a Firewire port), a serial port, network adapter 408, and/or a universal serial bus (USB).

In yet another aspect, a display device 411 can also be connected to the bus 413 via an interface, such as a display adapter 409. It is contemplated that the computer 401 can have more than one display adapter 409 and the computer 401 can have more than one display device 411. For example, a display device 411 can be a monitor, an LCD (Liquid Crystal Display), light emitting diode (LED) display, television, smart lens, smart glass, and/or a projector. In addition to the display device 411, other output peripheral devices can comprise components such as speakers (not shown) and a printer (not shown) which can be connected to the computer 401 via Input/Output Interface 410. Any step and/or result of the methods can be output in any form to an output device. Such output can be any form of visual representation, including, but not limited to, textual, graphical, animation, audio, tactile, and the like. The display device 411 and computer 401 can be part of one device, or separate devices.

The computer 401 can operate in a networked environment using logical connections to one or more remote computing devices 414a,b,c. By way of example, a remote computing device 414a,b,c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 401 and a remote computing device 414a,b,c can be made via a network 415, such as a local area network (LAN) and/or a general wide area network (WAN). Such network connections can be through a network adapter 408. A network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components can reside at various times in different storage components of the computer 401, and are executed by the one or more processors 403 of the computer 401. An implementation of education management software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning. Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
receiving, at an education management system, an organization profile of an organization, wherein the organization is associated with one or more professionals;
receiving a professional profile of a professional, wherein the professional profile permits the professional to access one or more professional features of the education management system for managing a professional education goal;
determining the professional is associated with the organization based on the professional profile and the organization profile; and
providing one or more organization features to the organization profile, wherein the one or more organization features manages the professional education goal of the professional associated with the organization.

2. The method of claim 1, wherein determining the professional is associated with the organization comprises:
comparing data entries of one or more fields of the organization profile with data entries of one or more fields of the professional profile; and
associating the professional profile with the organization profile when at least one of the data entries of the one or more fields of the professional profile is substantially similar to at least one of the data entries of the one or more fields of the organization profile.

3. The method of claim 1, further comprising:
receiving, from an education provider, a request to advertise an educational offering on the education management system; and
advertising the educational offering on the education management system.

4. The method of claim 3, wherein advertising the educational offering on the education management system comprises:
determining whether one or more data entries of one or more fields of the educational offering are substantially similar to one or more data entries of one or more fields of the professional profile; and
advertising the educational offering to the professional when the one or more data entries of the educational offering are substantially similar to the one or more data entries of the professional profile.

5. The method of claim 3, wherein advertising the educational offering comprises:
receiving a search request;
performing a search of a catalog of educational offerings based on the search request; and
providing the educational offering when the search matches the search request to one or more data entries of one or more fields of the educational offering.

6. The method of claim 3, wherein the education provider is the organization, and wherein the educational offering is only provided to professionals associated with the organization.

7. The method of claim 3, further comprising:
receiving a request from the professional to register for the educational offering;
providing a registration form for the educational offering to the professional;
receiving the registration form from the professional; and
associating the educational offering with the professional profile.

8. The method of claim 7, further comprising, providing the organization, associated with the professional, access to the educational offering associated with the professional profile.

9. The method of claim 7, further comprising:
receiving a notification that the professional completed the educational offering; and
adding the educational offering to a portfolio of completed educational offerings, wherein the portfolio is associated with the professional profile.

10. The method of claim 9, further comprising providing the organization, associated with the professional, access to the portfolio.

11. The method of claim 1, further comprising:
receiving an education requirement from the organization for the professional associated with the organization, wherein transmitting the education requirement by the organization is for the professional associated with the organization is an organization feature of the one or more organization features; and
assigning the education requirement to the professional profile, wherein the education requirement is based on an educational offering provided by an education provider.

12. The method of claim 11, wherein at least one of the education requirement and the educational offering is assigned to a group of professionals associated with the organization.

13. The method of claim 11, further comprising:
monitoring a completion status of the education requirement; and
providing notifications of the completion status to the organization.

14. A method, comprising:
receiving a plurality of educational offerings from one or more education providers, wherein the plurality of educational offerings have one or more offering data entries;
receiving one or more professional profiles from one or more professionals, wherein the one or more professional profiles have one or more professional data entries;
receiving one or more organization profiles from one or more organizations, wherein the one or more organization profiles have one or more organization data entries;
associating the one or more professional profiles with the one or more organization profiles, based on the one or more organization data entries and the one or more professional data entries;
providing at least one organization feature to any of the one or more organization profiles that are associated with at least one of the one or more professional profiles, wherein the at least one organization feature manages at least one professional feature provided to the one or more professional profiles; and
advertising at least a portion of the plurality of educational offerings to the one or more professionals of an associated organization based on at least the one or more organization data entries of the associated organization.

15. The method of claim 14, further comprising:
receiving an education requirement from the associated organization for a professional of the one or more professionals associated with the associated organization; and
assigning the education requirement to a professional profile of the professional, wherein the education requirement is based on one or more educational offerings.

16. The method of claim 14, further comprising:
receiving a request from a professional of the one or more professionals to register for at least one educational offering of the plurality of educational offerings corresponding to the professional;
providing a registration form to the professional for the at least one educational offering;
receiving the registration form from the professional; and
associating the at least one educational offering with a professional profile of the professional.

17. The method of claim 16, further comprising providing the associated organization, associated with the professional, access to the at least one educational offering associated with the professional profile.

18. The method of claim 16, further comprising:
receiving a notification that the professional completed the at least one educational offering; and
adding the at least one educational offering to a portfolio of completed educational offerings, wherein the portfolio is associated with the professional profile.

19. The method of claim 18, further comprising providing the associated organization, associated with the professional, access to the portfolio.

20. An apparatus, comprising:
a processor; and
a memory storing instructions that, when executed by the processor, configure the processor to,
receive an organization profile of an organization, wherein the organization is associated with one or more professionals,
receive a professional profile of a professional, wherein the professional profile permits the professional to access one or more professional features for managing a professional education goal,
determine the professional is associated with the organization based on the professional profile and the organization profile, and
provide one or more organization features to the organization profile, wherein the one or more organization features manages the professional education goal of the professional associated with the organization.
